(19) United States
(12) Patent Application Publication
(10) Pub. No.: US 2026/0318629 A1
(43) Pub. Date: Oct. 15, 2026

(54) SYSTEM FOR COOLING USING TRANS-ATMOSPHERIC HEAT TRANSFER AND METHOD THEREFOR

(71) Applicant: Quanterion Technologies Corporation, Palmetto, FL (US)

(72) Inventors: William Alan Klingbeil, Palmetto, FL (US); Joseph Allen Jacobs, Palmetto, FL (US)

(73) Assignee: Quanterion Technologies Corporation, Palmetto, FL (US)

(21) Appl. No.: 19/466,237

(22) Filed: Jan. 30, 2026

Related U.S. Application Data
(60) Provisional application No. 63/751,349, filed on Jan. 30, 2025.

(51) Int. Cl. F28F 13/18

(52) U.S. Cl. CPC F28F 13/185; F28F 2245/06; F28F 2255/08; F28F 2260/00

(57) ABSTRACT

A system that facilitates the efficient transfer of heat from a waste heat source to trans-atmospheric wavelengths which most efficiently and effectively transfer infrared radiation through the atmosphere and into space, and a method therefor. The system can include an external body having input and output connections that are configured to facilitate the flow of a heat transfer medium therein, a transparent top cover designed to be transparent to specifically selected wavelengths for efficient and effective transmission through the atmosphere, while blocking and/or reflecting undesirable wavelengths which do not easily transmit through the atmosphere, an enclosure body including an interior chamber and another transparent top cover, internal heat transfer pipes to circulate input heat transfer mediums, such as liquid or gas, through the system, a heat transfer radiating plate and a specifically designed wavelength radiating surface to convert waste heat into specifically selected wavelengths, which will enable effective and efficient transmission of the waste heat through the top covers and through the atmosphere. In a preferred embodiment, the wavelength radiating surface comprises a metallic foil having mechanically stamped microstructures with a black anodized coating for high emissivity in the 8-13 micrometer range.

### CROSS-REFERENCE TO RELATED APPLICATIONS

This application claims the benefit of U.S. Provisional Patent Application Ser. No. 63/751,349, filed Jan. 30, 2025, the disclosure of which is incorporated herein by reference in its entirety.

### STATEMENT REGARDING FEDERALLY SPONSORED RESEARCH OR DEVELOPMENT

Not applicable.

### COPYRIGHT NOTICE

A portion of this disclosure contains material which is subject to copyright protection. The copyright owner has no objection to the photocopy reproduction by anyone of the patent document or the patent disclosure in exactly the form it appears in the Patent and Trademark Office patent file or records but otherwise reserves all copyright rights whatsoever. 37 C.F.R 1.71(d).

### REFERENCES CITED

### U.S. Patent Documents

U.S. Pat. No. 11,841,171B2—SkyCool Systems, Inc.—Radiative cooling systems
U.S. Pat. No. 12,366,386B2—SkyCool Systems, Inc.—Radiative cooling systems
U.S. Pat. No. 11,084,944—Coating to cool a surface by passive radiative cooling
U.S. Pat. No. 10,054,489—Infrared radiation emission surface having high thermal emissivity
U.S. Pat. No. 6,753,075B1—Infrared camouflage system
U.S. Pat. No. 6,249,005—Infrared radiation filament and method of manufacture
U.S. Pat. No. 5,175,975A—Compact vacuum insulation

### Foreign Patent Documents

DE102015212279A1—Thermal embossing process

### Other Publications

Raman, A. P., et al. (2014) “Passive radiative cooling below ambient air temperature under direct sunlight” Nature 515, 540-544.
Rephaeli, E., Raman, A., Fan, S. (2013) “Ultrabroadband photonic structures to achieve high-performance daytime radiative cooling” Nano Letters 13, 1457-1461.
Goldstein, E. A., Raman, A. P., Fan, S. (2017) “Sub-ambient non-evaporative fluid cooling with the sky” Nature Energy 2, 17143.
Zhai, Y., et al. (2017) “Scalable-manufactured randomized glass-polymer hybrid metamaterial for daytime radiative cooling” Science 355, 1062-1066.
Li, T., et al. (2019) “A radiative cooling structural material” Science 364, 760-763.
Gustavsen, A., Berdahl, P. (2003) “Spectral emissivity of anodized aluminum and the thermal transmittance of aluminum window frames” Nordic Journal of Building Physics Vol. 3.
Hagen, N. (2022) “Review of thermal infrared polarimetry, part 2: experiment” Optical Engineering 61(8), 080901.
Hossain, M. M., Gu, M. (2016) “Radiative Cooling: Principles, Progress, and Potentials” Advanced Science 3, 1500360.

### BACKGROUND OF THE INVENTIVE CONCEPT

### 1. Field of the Invention

The present inventive concept relates to the efficient transfer of heat from a waste heat source to trans-atmospheric wavelengths which most effectively transfer infrared radiation through the atmosphere and into space.

### 2. Description of the Related Art

The management of waste heat is a persistent challenge across residential, commercial, and industrial sectors. Conventional cooling systems, such as air conditioners and refrigeration cycles, are energy-intensive and often contribute to the urban heat island effect by simply moving heat from an interior space to the immediate exterior environment. These systems do not remove thermal energy from the local environment but merely relocate it, while consuming significant electrical power in the process.

Other solutions include passive cooling technologies, such as radiative cooling paints and films. While these materials can provide some benefit by reflecting solar radiation and emitting thermal radiation, they suffer from several drawbacks. Their performance can be significantly degraded by environmental fouling from dirt, dust, and moisture. Furthermore, they are typically passive systems that are not integrated into active heat management loops, limiting their ability to cool specific, high-output waste heat sources. Their efficiency is often limited, and they lack the robustness required for large-scale, high-performance applications.

Prior art in radiative cooling includes multilayer photonic structures using materials such as HfO2 and SiO2, polymer-based coatings with microsphere inclusions, and various surface treatments. However, these approaches typically rely on expensive lithographic fabrication processes, random porosity structures with inconsistent performance, or passive coatings that cannot be integrated with active thermal management systems.

Therefore, there is a need for a robust, efficient, and scalable cooling system that can actively draw heat from a source and reject it from the local environment entirely, without the high energy consumption of conventional refrigeration cycles. There is a further need for such a system to be protected from environmental degradation to ensure long-term, consistent performance, and for a manufacturing method that enables cost-effective mass production.

### SUMMARY OF THE INVENTIVE CONCEPT

The present general inventive concept relates to a system that performs the efficient transfer of heat from a waste heat source to trans-atmospheric wavelengths which most efficiently and effectively transfer infrared radiation through the atmosphere, off the planet and into space, and a method therefor. More particularly, but not exclusively, the present inventive concept relates to a system that facilitates the efficient transfer of waste heat from a waste heat source into specific trans-atmospheric wavelengths which most efficiently and effectively transfer infrared radiation through the atmosphere and into space, and a method therefor.

Additional features and utilities of the present general inventive concept will be set forth in part in the detailed description which follows and, in part, will be obvious from the description, or may be learned by practice of the general inventive concept.

The foregoing and/or other features and utilities of the present general inventive concept may be achieved by providing a system comprising an enclosure body having a top opening; a heat transfer radiating plate disposed within the enclosure body, the plate comprising one or more internal pipes configured to circulate a heat transfer medium; a wavelength radiating surface disposed on the heat transfer radiating plate, wherein the surface is engineered to have a high thermal emissivity within a predetermined spectral window; and a top cover disposed over the top opening of the enclosure body, wherein the top cover is substantially transparent to radiation within the predetermined spectral window.

In an example embodiment, the enclosure body defines an interior chamber that is evacuated to form a vacuum.

In another example embodiment, a collimation grating is disposed between the wavelength radiating surface and the top cover.

In a preferred embodiment, the wavelength radiating surface comprises a metallic foil substrate having a plurality of radiating microstructures formed by mechanical stamping, the microstructures having dimensions selected for resonant thermal emission within the atmospheric transparency window of 8 to 13 micrometers, and a black anodized coating having thermal emissivity greater than 0.85.

The foregoing and/or other features and utilities of the present general inventive concept may also be achieved by providing a method for cooling a waste heat source, comprising receiving a heated fluid medium into a cooling system, transferring waste heat to an engineered radiating surface, converting the waste heat into infrared radiation within a predetermined spectral window, radiating the infrared radiation into space, and returning the cooled fluid to the source.

In another example embodiment, a plurality of systems may be connected in series, or daisy-chained, to achieve progressively lower temperatures.

Additional features and utilities of the present general inventive concept will be set forth in part in the description which follows and, in part, will be obvious from the description, or may be learned by practice of the general inventive concept.

### BRIEF DESCRIPTION OF THE DRAWINGS

These and/or other features and utilities of the present inventive concept will become apparent and more readily appreciated from the following description of the embodiments, taken in conjunction with the accompanying drawings of which:

FIG. 1 illustrates a graph illustrating an optimal wavelength range which most easily and effectively transfers infrared radiation through the atmosphere, off the planet Earth and into space, which is accomplished with the system according to the example embodiments of the present inventive concept.

FIG. 2 illustrates an external body of a system to transfer heat from a waste heat source to trans-atmospheric wavelengths which most effectively transfer infrared radiation through the atmosphere off the planet Earth and into space, according to an example embodiment of the present inventive concept.

FIG. 3 illustrates an enclosure body of an interior portion of the system illustrated in FIG. 2, according to an example embodiment of the present inventive concept.

FIG. 4 illustrates an enclosure body of the system illustrated in FIG. 2, according to another example embodiment of the present inventive concept.

FIG. 5 illustrates a magnified view of an embodiment of the wavelength radiating surface, showing a plurality of radiating microstructures, according to an example embodiment of the present inventive concept.

FIG. 6 illustrates an exploded isometric assembly view of the system illustrated in FIG. 2, showing the relationship between the various components, according to an example embodiment of the present inventive concept.

FIG. 7 illustrates the system of FIG. 2 installed in an operational environment, according to an example embodiment of the present inventive concept.

FIG. 8 illustrates a plurality of systems connected in a daisy-chain configuration, according to an example embodiment of the present inventive concept.

FIG. 9 illustrates a flowchart of a method for cooling a waste heat source using trans-atmospheric heat transfer, according to an example embodiment of the present inventive concept.

The drawings illustrate a few example embodiments of the present inventive concept and are not to be considered limiting in its scope, as the overall present inventive concept may admit to other equally effective embodiments.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures. Also, while describing the present general inventive concept, detailed descriptions about related well-known functions or configurations that may diminish the clarity of the points of the present general inventive concept may be omitted.

It will be understood that although the terms “first” and “second” are used herein to describe various elements, these elements should not be limited by these terms. These terms are only used to distinguish one element from another element. Thus, a first element could be termed a second element, and similarly, a second element may be termed a first element without departing from the teachings of this disclosure.

Expressions such as “at least one of,” when preceding a list of elements, modify the entire list of elements and do not modify the individual elements of the list.

All terms including descriptive or technical terms which are used herein should be construed as having meanings that are obvious to one of ordinary skill in the art. However, the terms may have different meanings according to the intention of the lexicographer(s) of this document, case precedents, or the appearance of new technologies. Also, some terms may be arbitrarily selected by the inventors, and in this case, the meaning of the selected terms will be described in detail in the detailed description herein. Thus, the terms used herein should be defined based on the generally defined meaning of the terms together with the description presented throughout this specification.

Hereinafter, one or more exemplary embodiments of the present general inventive concept will be described in detail with reference to accompanying drawings.

Example embodiments of the present general inventive concept are directed to a system that facilitates the efficient transfer of waste heat from a waste heat source into specific trans-atmospheric wavelengths which most effectively transfer infrared radiation through the atmosphere off the planet and into space, and a method therefor.

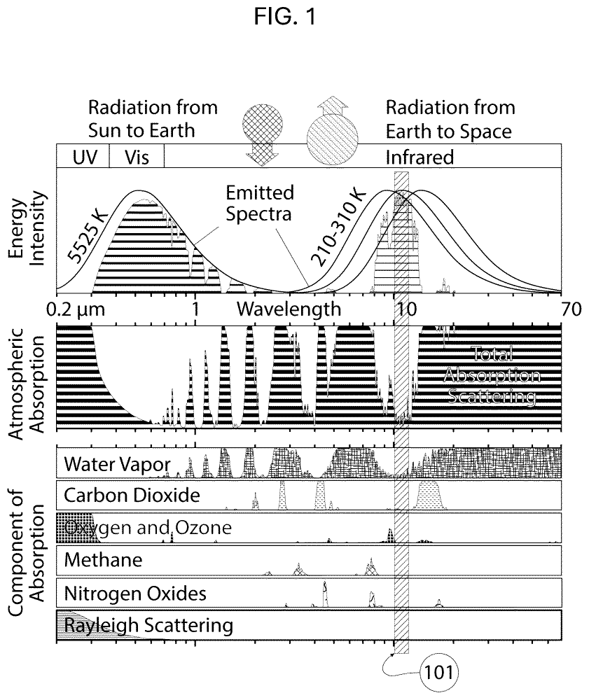

FIG. 1 is a graph 100 illustrating a wavelength range, from 7 to 15 micrometers (μm) with the optimal range of 10 to 12 micrometers (μm), which most easily and effectively transfers infrared radiation through the atmosphere off the planet Earth and into space. This radiation wavelength range, generated to be emitted by the present inventive concept, intentionally avoids any interference that would otherwise be caused by atmospheric water vapor and various gases such as carbon dioxide, oxygen and ozone, methane, nitrogen oxides, Rayleigh scattering, as well as other sources of atmospheric absorption and interference.

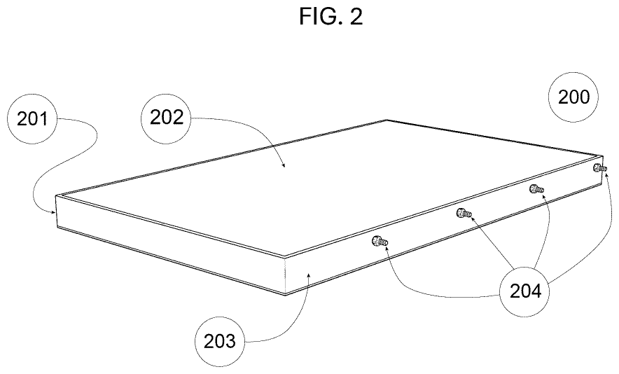

FIG. 2 illustrates a system 200 to transfer heat from a waste heat source to trans-atmospheric wavelengths which most effectively transfer infrared radiation through the atmosphere off the planet Earth and into space, according to an example embodiment of the present inventive concept. Referring to FIG. 2, the system 200 can include an external body 201 that is configured to enclose an interior section 202 thereof. The external body 201 can be fabricated from a variety of different materials, such as, for example metals, glass, ceramics, plastics, etc., which will retain undesired wavelengths from being emitted outside the external body 201 while blocking undesired elements from penetrating the external body 201 from the atmosphere. The system 200 can also include a top cover 203, which is specifically designed to be transparent to specifically selected wavelengths for efficient and effective transmission through the atmosphere. Additional desirable characteristics is that the top cover blocks and/or reflects undesirable wavelengths which do not easily transmit through the atmosphere. In an example embodiment, the exterior surfaces of the top cover 203 may undergo surface treatments to prevent fouling, which could compromise emission efficiency.

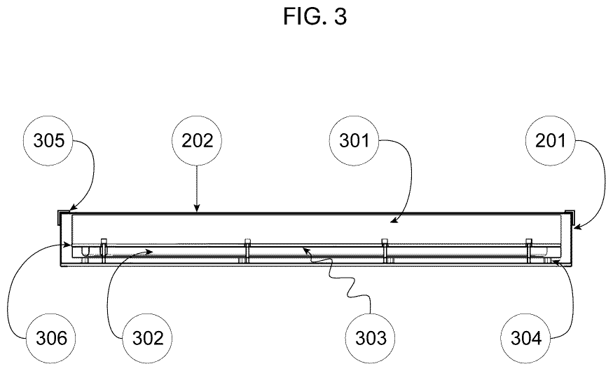

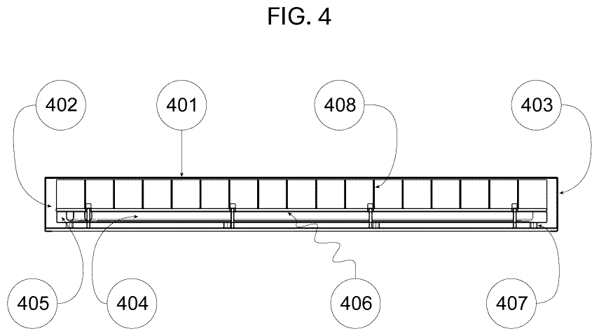

The external body 201 of the system 200 according to the example embodiment of FIG. 2 may also include input and output connections 204 that are configured to facilitate the flow of a heat transfer medium, such as, for example, a liquid or a gas, depending on the application of the overall system 200. The input and output connections 204 are preferably connected to internal heat transfer pipes, which are described in detail below with reference to FIGS. 3 and 4. It is to be noted that the input and output connections 204 are interchangeable since the transfer of such heat transfer mediums are non-directional.

FIG. 3 illustrates an enclosure body 301 of an interior portion of the system 200 illustrated in FIG. 2, according to an example embodiment of the present inventive concept. The enclosure body 301 may be formed of various materials, such as, for example, metals, ceramics plastics, etc. The enclosure body 301 can include an interior chamber 302, which is evacuated to create a vacuum environment. The enclosure body 301 can also include a top cover 303, which comprises similar or the same characteristics as the top cover 203 of FIG. 2, which is designed to be transparent to specifically selected wavelengths for efficient and effective transmission through the atmosphere, while blocking and/or reflecting undesirable wavelengths which do not easily transmit through the atmosphere, such as visible wavelengths, ultraviolet wavelengths, or portions of wavelengths of the infrared spectrum. In an example embodiment, the exterior surfaces of the top cover 303 may undergo surface treatments to prevent fouling, which could compromise emission efficiency.

Within the enclosure body 301 can be provided internal heat transfer pipes 304, which are configured to circulate the input heat transfer medium, such as liquid or gas, through the system 200. The internal heat transfer pipes 304 can also be configured to facilitate the transfer of waste heat to a heat transfer radiating plate 305. The radiating plate 305 is made from thermally conductive materials such as aluminum or copper with the embedded cooling pipes 304 also consisting of a thermally conductive material, again such as aluminum or copper. The radiating plate 305 has a surface coating 306 or surface treatment which provides a specific wavelength radiating surface 306 can be disposed on a top surface of the heat transfer radiating plate 305 to convert waste heat into specifically selected wavelengths, which will enable effective and efficient transmission of the waste heat through the top cover 303, through the top cover 203, and through the atmosphere. The wavelength radiating surface 306 is configured to radiate the generated wavelengths toward and through the top cover 303, as well as through the top cover 203.

The evacuated chamber 302 provides a disconnection of the internal components from the ambient environment, thereby protecting the wavelength radiating surface 306 from environmental degradation and minimizing parasitic thermal effects. According to an example embodiment, the surface of the wavelength radiating surface 306 can include a surface treatment, including, for example, microsphere coatings, lithographic etching, fractal emission surfaces, fabric coverings, or mechanically stamped microstructures. The geometry of the wavelength radiating surface 306 may be flat, concave, convex, or include other configurations, allowing for shaping of the angle or direction of the emitted wavelengths, and to assist in the focusing and collimation of the emitted light.

The enclosure body 301 can also include standoffs 307 provided therein to separate the heat transfer radiating plate 305 from the enclosure body 301 in order to minimize or eliminate ambient heat transfer into the system 200.

FIG. 4 illustrates an enclosure body 401 of the system 200 illustrated in FIG. 2, according to another example embodiment of the present inventive concept. Similar to the enclosure body 301 illustrated in the example embodiment of FIG. 3, the enclosure body 401 may be formed of various materials, such as, for example, metals, glass, ceramics plastics, etc. The enclosure body 401 can include an interior chamber 402, which is evacuated to create a vacuum environment therein. The enclosure body 401 can also include a top cover 403, which comprises similar or the same characteristics as the top cover 203 of FIG. 2. The top cover 403 is designed to be transparent to specifically selected wavelengths for efficient and effective transmission of these wavelengths through the atmosphere while blocking and/or reflecting undesirable wavelengths which do not easily transmit through the atmosphere, such as visible wavelengths, ultraviolet wavelengths, or portions of wavelengths of the infrared spectrum. In an example embodiment, the exterior surfaces of the top cover 403 may undergo surface treatments to prevent fouling, which could compromise emission efficiency.

Within the enclosure body 401 can be provided internal heat transfer pipes 404, which are configured to circulate the heat transfer medium input therein, such as liquid or gas, through the system 200. The internal heat transfer pipes 404 can also be configured to facilitate the transfer of waste heat to a heat transfer radiating plate 405. The radiating plate 405 is made from thermally conductive materials such as aluminum or copper with the embedded cooling pipes 404 also consisting of a thermally conductive material, again such as aluminum or copper. The radiating plate 405 has a surface coating 406 or surface treatment which provides a specific wavelength radiating surface 406 can be disposed on a top surface of the heat transfer radiating plate 405 to convert waste heat into specifically selected wavelengths, which will enable efficient and effective transmission of the waste heat through the atmosphere. The wavelength radiating surface 406 is configured to radiate the generated wavelengths toward and through the top cover 403. The evacuated chamber 402 provides a disconnection from the ambient environment, thereby protecting the wavelength radiating surface 406 from environmental degradation and minimizing parasitic thermal effects. According to an example embodiment, the surface of the wavelength radiating surface 406 can include a surface treatment, including, for example, microsphere coatings, lithographic etching, fractal emission surfaces, fabric coverings, or mechanically stamped microstructures. The geometry of the wavelength radiating surface 406 may be flat, concave, convex, or other configurations, allowing for shaping of the angle or direction of the emitted wavelengths, and to assist in the focusing and collimation of the infrared light.

The enclosure body 401 can also include standoffs 407 provided to separate the heat transfer radiating plate 405 from the enclosure body 401 in order to minimize or eliminate ambient heat transfer into the system 200. However, in this example embodiment the enclosure body 401 can also include a collimation grating 408 that prevents off-axis input radiation from entering the enclosure body 401 and coupling to the radiation plate 405, while also facilitating vertical collimation of emitted infrared light.

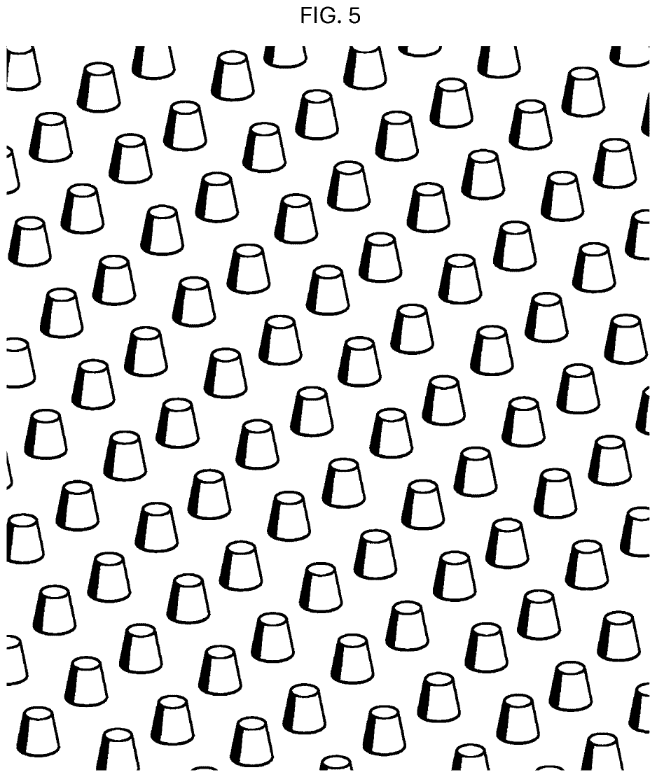

FIG. 5 is a magnified view providing specific detail of an embodiment of the wavelength radiating surface 306 (or 406). In a preferred embodiment, the wavelength radiating surface comprises a metallic foil substrate, preferably copper foil having a thickness between 10 and 100 micrometers. The foil is processed by mechanical stamping to create a plurality of radiating microstructures. The microstructures have a height dimension between 2 and 15 micrometers and are dimensioned to exhibit resonant thermal emission within the atmospheric transparency window of 8 to 13 micrometers. A black anodized coating is disposed over the microstructures, the coating having a thickness between 15 and 50 micrometers and a thermal emissivity greater than 0.85 in the 8-13 micrometer wavelength range. The microstructures may be arranged in a row-column array pattern, an interleaved pattern, or a hexagonal close-packed pattern.

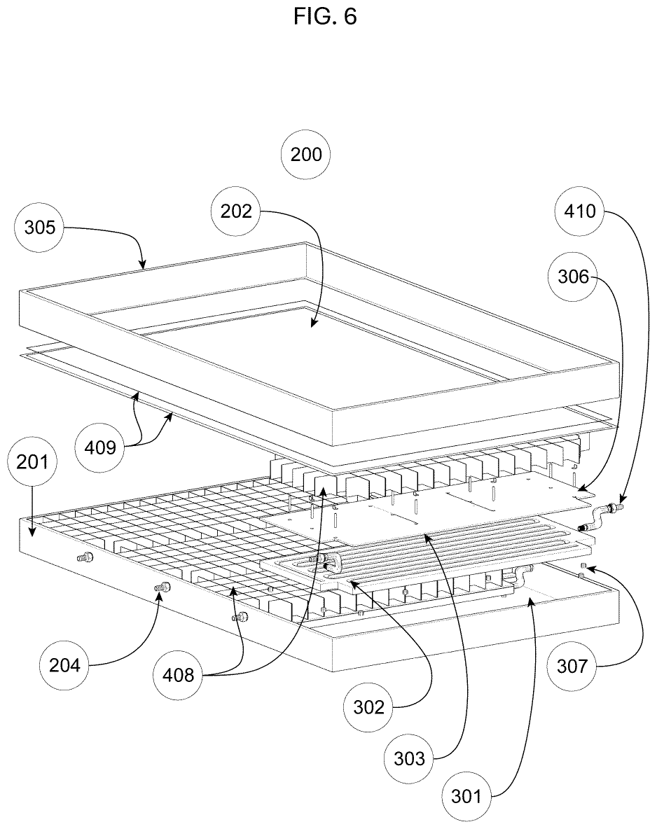

FIG. 6 is an exploded isometric assembly view illustrating the manufacturing and assembly relationship between components. From top to bottom: a top cover assembly 200 including the transparent top cover 202; an enclosure body 201; a collimation grating 408; a wavelength radiating surface 306 disposed on a radiating plate assembly including internal channel structure 302; support standoffs 303; and a base assembly 301 having fluid connection ports 204. The exploded view illustrates how the components are assembled to form the complete system 200.

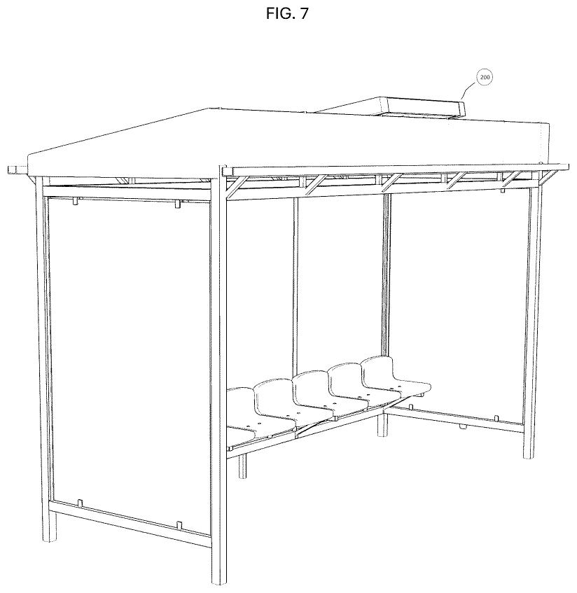

FIG. 7 illustrates the system 200 installed in an operational environment, specifically a transit shelter structure. The system 200 is mounted on the roof of the shelter, where it receives waste heat from the enclosed space below and radiates it through the atmosphere into space. This example embodiment illustrates one of many possible applications for the system 200, which may also be deployed on building rooftops, vehicle surfaces, industrial equipment enclosures, and other structures where passive cooling is desired.

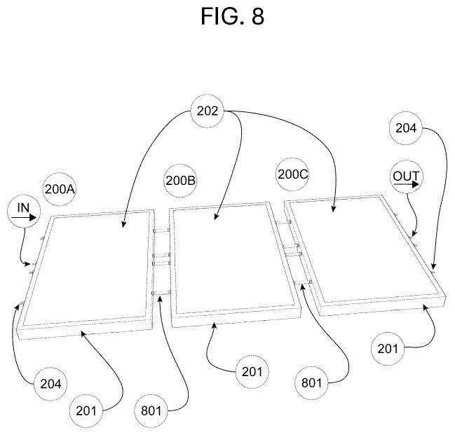

FIG. 8 illustrates a daisy-chain configuration wherein a plurality of systems 200A, 200B, 200C are connected in series. A heated transfer medium enters the first system 200A via an input connection, is partially cooled, and exits to enter the second system 200B. The process repeats through system 200C. Interconnection piping 801 connects the systems. This configuration allows the collective system to achieve lower output temperatures than a single system 200 can achieve alone.

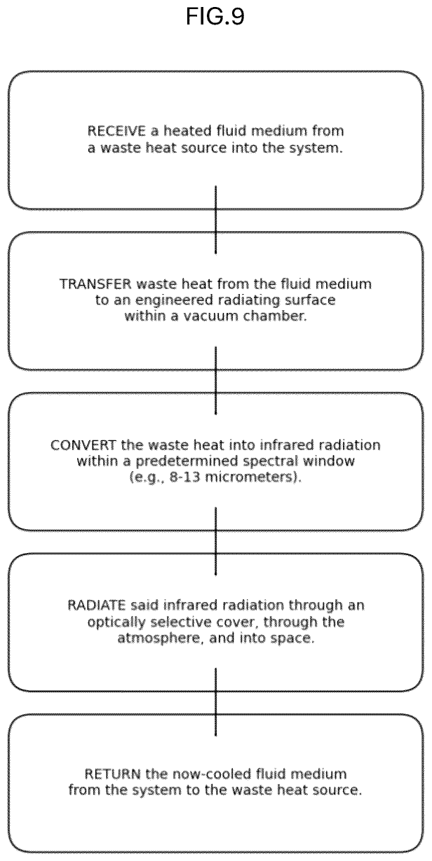

FIG. 9 is a flowchart illustrating the steps of the cooling method according to an example embodiment of the present inventive concept. The method comprises: receiving a heated fluid medium from a waste heat source into the system; transferring waste heat from the fluid medium to an engineered wavelength radiating surface within a vacuum chamber; converting the waste heat into infrared radiation within a predetermined spectral window, such as 8-13 micrometers; radiating said infrared radiation through an optically selective cover, through the atmosphere, and into space; and returning the now-cooled fluid medium from the system to the waste heat source.

It is to be noted that the system 200 can be daisy-chained in series, as illustrated in FIG. 8, allowing multiple radiator systems 200 to collectively achieve lower temperatures than a single system 200 can achieve, thereby providing significantly reduced operating temperatures in heat exchangers.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A system for cooling, comprising: an enclosure body having a top opening; a heat transfer radiating plate disposed within the enclosure body, the plate comprising one or more internal pipes configured to circulate a heat transfer medium; a wavelength radiating surface disposed on the heat transfer radiating plate, wherein the surface is engineered to have a high thermal emissivity within a predetermined spectral window; and a top cover disposed over the top opening of the enclosure body, wherein the top cover is substantially transparent to radiation within the predetermined spectral window.

2. The system of claim 1, wherein the enclosure body defines an interior chamber that is evacuated to form a vacuum.

3. The system of claim 1, wherein the wavelength radiating surface comprises a plurality of radiating microstructures.

4. The system of claim 3, wherein the wavelength radiating surface is a metallic foil bonded to the heat transfer radiating plate.

5. The system of claim 1, wherein the top cover is substantially reflective of solar radiation.

6. The system of claim 1, further comprising a collimation grating disposed between the wavelength radiating surface and the top cover.

7. The system of claim 6, wherein the collimation grating comprises a plurality of parallel fins oriented substantially perpendicular to the heat transfer radiating plate.

8. A method for cooling a waste heat source, the method comprising the steps of: receiving a heated fluid medium from the waste heat source into a cooling system; transferring waste heat from the fluid medium to an engineered wavelength radiating surface; converting the waste heat into infrared radiation substantially within a predetermined trans-atmospheric spectral window; radiating the infrared radiation from the cooling system through the atmosphere and into space; and returning the fluid medium, having been cooled, from the cooling system to the waste heat source.

9. The method of claim 8, wherein the predetermined trans-atmospheric spectral window is between 8 and 13 micrometers.

10. The method of claim 8, wherein the step of transferring waste heat occurs within a vacuum environment.

11. The method of claim 8, further comprising the step of collimating the infrared radiation prior to the step of radiating.

12. A scalable cooling apparatus, comprising: at least a first cooling system and a second cooling system, each cooling system according to claim 1; wherein an output for the heat transfer medium of the first cooling system is fluidically connected to an input for the heat transfer medium of the second cooling system, such that the heat transfer medium is cooled sequentially by the first and second cooling systems.

13. A wavelength-selective radiating surface for passive radiative cooling, comprising: a metallic foil substrate having a first surface and a second surface; a plurality of radiating microstructures formed on said first surface by mechanical stamping, said microstructures having a height dimension between 2 and 15 micrometers; wherein said radiating microstructures are dimensioned to exhibit resonant thermal emission within the atmospheric transparency window of 8 to 13 micrometers.

14. The wavelength-selective radiating surface of claim 13, wherein said metallic foil substrate comprises copper foil having a thickness between 10 and 100 micrometers.

15. The wavelength-selective radiating surface of claim 13, wherein said radiating microstructures have a diameter between 2 and 10 micrometers and a center-to-center spacing between 5 and 20 micrometers.

16. The wavelength-selective radiating surface of claim 13, further comprising a black anodized coating disposed over said radiating microstructures, said coating having a thickness between 10 and 50 micrometers and a thermal emissivity greater than 0.85 in the 8-13 micrometer wavelength range.

17. The wavelength-selective radiating surface of claim 13, wherein said plurality of radiating microstructures are arranged in one of: a row-column array pattern, an interleaved pattern, or a hexagonal close-packed pattern.

18. A method for manufacturing a wavelength-selective radiating surface, comprising the steps of: providing a metallic foil substrate; providing a stamping die having a plurality of cavities dimensioned to create microstructures resonant at wavelengths within the atmospheric transparency window; mechanically pressing said stamping die against said metallic foil substrate to form a plurality of radiating microstructures; and applying a high-emissivity coating to said microstructures.

19. The method of claim 18, wherein said step of mechanically pressing comprises one of: hydraulic pressing, roll-to-roll embossing, or hot stamping.

20. The method of claim 18, wherein said step of applying a high-emissivity coating comprises black anodization of said metallic foil substrate.

21. The method of claim 18, wherein said cavities in said stamping die have depths between 3 and 12 micrometers and diameters between 2 and 10 micrometers, such that the resulting microstructures exhibit quarter-wave to full-wave resonance at wavelengths between 8 and 13 micrometers.

22. A system for cooling according to claim 1, wherein the wavelength radiating surface comprises: a copper foil bonded to the heat transfer radiating plate; a plurality of stamped radiating microstructures formed in said copper foil, said microstructures having dimensions selected for resonant emission at trans-atmospheric wavelengths; and a black anodized layer disposed over said microstructures.
